(19) United States
(12) Patent Application Publication
(10) Pub. No.: US 2015/0302767 A1
(43) Pub. Date: Oct. 22, 2015

(54) EXERCISE RECOMMENDATION ENGINE WITH SAFTEY-BASED RISK VALUE ESTABLISHMENT

(71) Applicant: PrimeWellness LLC, Boulder, CO (US)

(72) Inventors: Matthew Henderson, Boulder, CO (US); Blake Henderson, Washington, DC (US)

(21) Appl. No.: 14/692,183

(22) Filed: Apr. 21, 2015

Related U.S. Application Data
(60) Provisional application No. 61/982,372, filed on Apr. 22, 2014.

(51) Int. Cl. G09B 19/00; G09B 7/00

(52) U.S. Cl. CPC G09B 19/003; G09B 7/00

(57) ABSTRACT

System and methods for receiving an end user input via a brief question-and-answer framework, and using the information to generate a baseline personalized exercise regime and/or enabling an end-user of an online exercise application to change exercise difficulty levels by interacting with a control panel on the application graphical user interface. The end-user may cause the application to retrieve an easier or harder exercise video in order to achieve an adaptable, personalized level of difficulty. For example, if an end user begins watching an exercise of a given difficulty level within a module, the use may input a command to transition to a more (or less) difficult exercise within that module. The application will retrieve a new exercise and present the newly retrieved exercise to the end user. A “storyboard” depicting each of the exercises in the program may be depicted in a small row of tiles below a video player.

### CROSS-REFERENCE TO RELATED APPLICATIONS

This application claims the benefit of priority to U.S. Provisional Patent Application No. 61/982,372 filed Apr. 22, 2014 the disclosure of which is incorporated herein by reference in its entirety.

### BACKGROUND

Web-based health and wellness applications in a variety of fields such as occupational therapy, sports & fitness, rehabilitation therapy, and others facilitate on-demand access to health and wellness exercise information. Such routines provide a narrative of exercises, often as videos, that are played by end users in, e.g., a web browser or media player. Some web-based programs are tailored for a particular fitness level of the end user. However, if the web-based program is not at an appropriate level for the end user, the benefits of such programs is reduced or an end user may overexert him/herself, leading to an injury.

### SUMMARY

Disclosed herein are systems and methods for enabling an end-user of an online exercise application to establish a baseline exercise program and/or change exercise difficulty levels by interacting with a control panel on the application graphical user interface. The end-user may cause the application to retrieve an easier or harder exercise video in order to achieve an adaptable, personalized level of difficulty.

In accordance with some aspects, there is provided a method for selecting a baseline exercise program based on a question-and-answer computing device module. The method may include communicating a web page from a website associated with exercise application provider to an end user at a computing device. The method may also include providing to the end user, through the web page, a first question related to ability of the end user. The method may also include providing to the end user, through the web page, a second question related to safety of the end user. The method may also include receiving answers provided by the end user to the first and second questions and establishing a risk value based on the received answers to the first and second questions. The method may also include determining if the risk value exceeds a predetermined risk threshold and then selecting a predetermined safe exercise program as the baseline exercise program. The method may include determining if the risk value does not exceed a predetermined risk threshold and then selecting an exercise program as the baseline exercise program that is more rigorous than the predetermined safe exercise.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is simplified block diagrams illustrating an example environment;

FIG. 2A illustrates an exercise program of FIG. 1 having modules at various levels of difficulty;

FIG. 2B illustrates an exercise program of FIG. 1 having modules at various levels of difficulty;

FIG. 2C illustrates an exercise program of FIG. 1 having modules at various levels of difficulty;

FIG. 3A illustrates an operational flow diagram of an example process in accordance with the present disclosure;

FIG. 3B illustrates an operational flow diagram of an example process for establishing the baseline program in accordance with the present disclosure;

FIGS. 4A, 4B, and 4C illustrate a control panel in accordance with the present invention;

FIGS. 5A, 5B, 5C, 5D, and 5E illustrate exemplary user interfaces; and

FIG. 6 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

Overview

In accordance with the present disclosure, there is provided a system and method for receiving an end user input via a brief question-and-answer framework, and using the information to generate a baseline personalized exercise regime. For example, a question-and-answer method can include four questions related to the end user's goals, focus, ability, and/or safety to ascertain the end user's current level of physical function.

Optionally or additionally, the provided system and method enables an end user of an online exercise application to change exercise difficulty levels by interacting with a control panel on the application graphical user interface. The end-user may cause the application to retrieve an easier or harder exercise video in order to achieve an adaptable, personalized level of difficulty.

For example, if an end user begins watching an exercise of a given difficulty level within a module, the use may input a command to transition to a more (or less) difficult exercise within that module. The application will retrieve a new exercise and present the newly retrieved exercise to the end user from, e.g., the beginning. For example, in accordance with some implementations, if the end user progresses 30 seconds into a video and inputs the command to change the level of difficulty, the newly retrieved video will begin at time 0:00. Hence, the total workout time may be extended when the end user inputs a command to change the level of difficulty. The degree to which the session is extended depends on the number of times the end user changes the level of difficulty.

Optionally or additionally, a “storyboard” depicting each of the exercises in the program is depicted in a small row of tiles below a video player. When the level of difficulty within a module is changed, the relevant tile within the overall storyboard will change to denote the change to a different exercise. This mechanism provides the end user with additional visual feedback

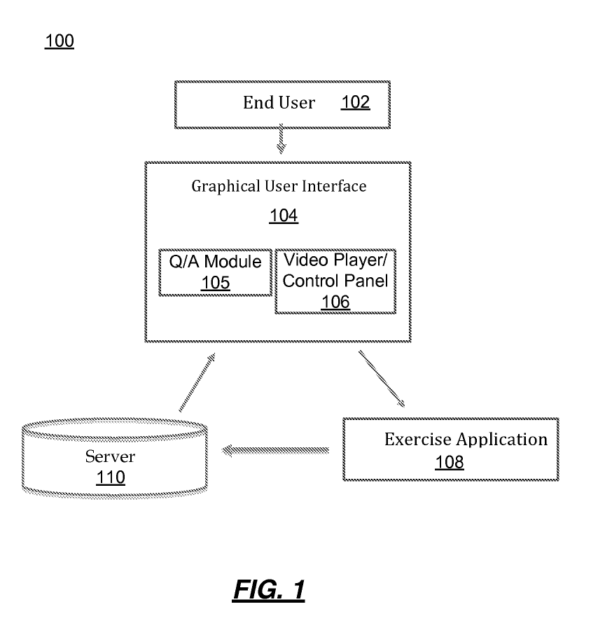

Referring to FIG. 1, there is illustrated an example environment 100 in which aspects of the present disclosure may be implemented. An end user 102 may interact with a graphical user interface 104 by inputting a programming command. The input may be received in a variety of ways depending on the computing device the end-user 102 is using to interact with the program. For example, if the case of a tablet computer, the user may tap a button on the screen with their finger, or stylus, causing the command to be relayed to produce the exercise of a different difficulty level. For a laptop computer, the end-user may utilize a mouse and/or keyboard to input the same command.

The graphical user interface 104 can include a question-and-answer module 105 and a video player/control panel 106. The question-and-answer module 105 and a video player/control panel 106 can be displayed on, e.g., a webpage provided by website associated with an exercise application provider, such as PrimeWellness.com. The question-and-answer module 105 and a video player/control panel 106 may be rendered using Hypertext Markup Language (HTML5). HTML5 adheres to established Internet standards, enabling the web application to maintain a consistent experience across a wide variety of computing devices and Internet browsers.

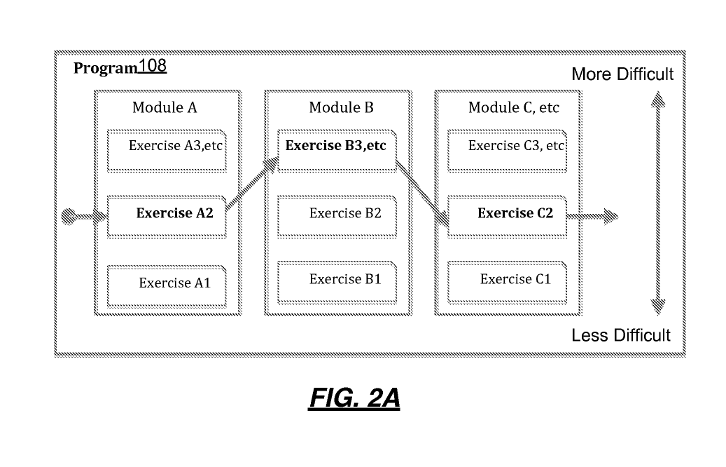

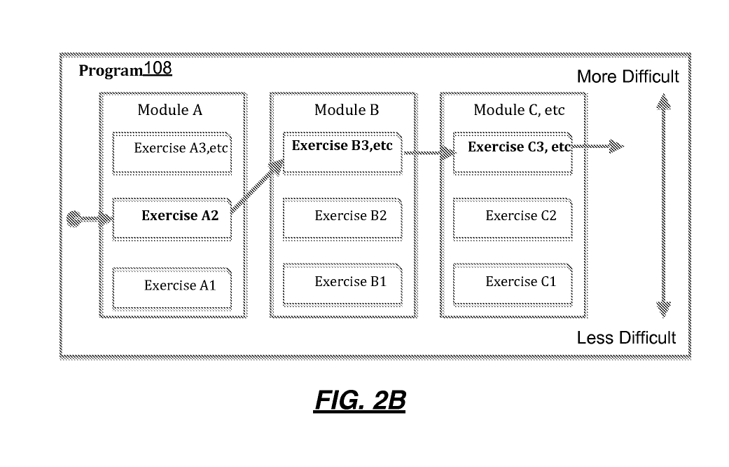

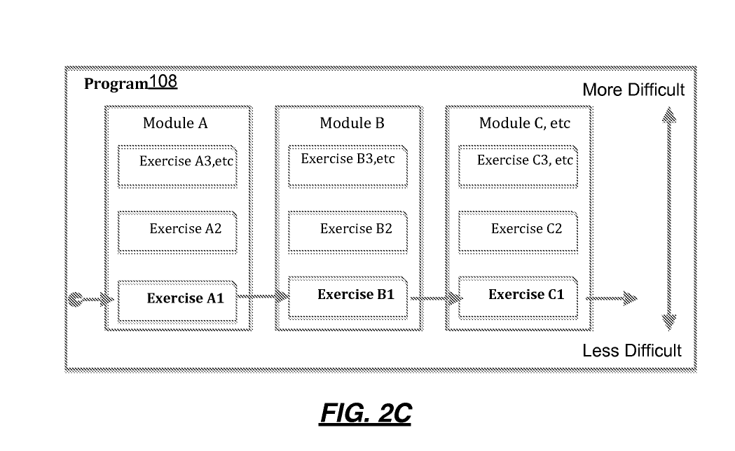

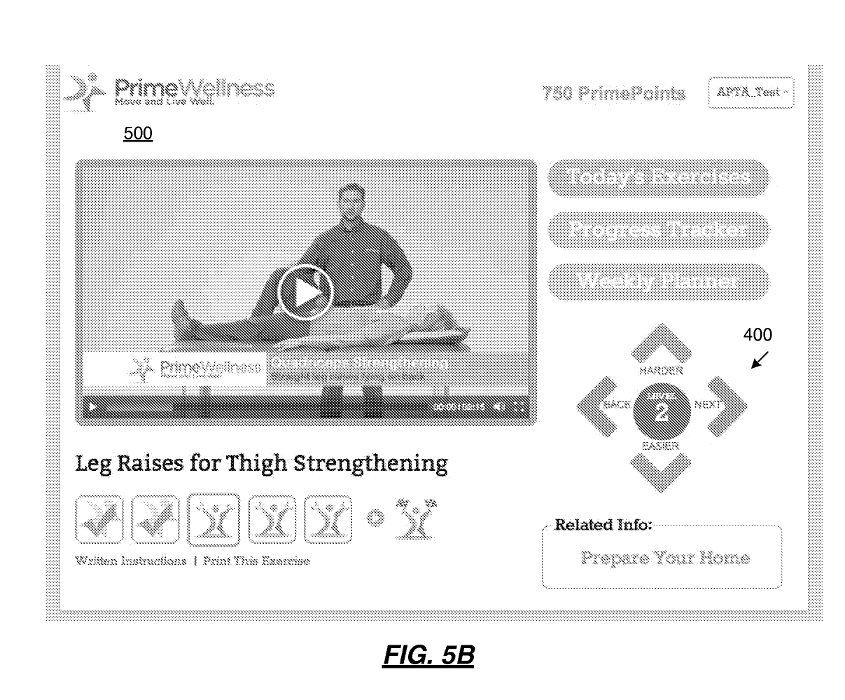

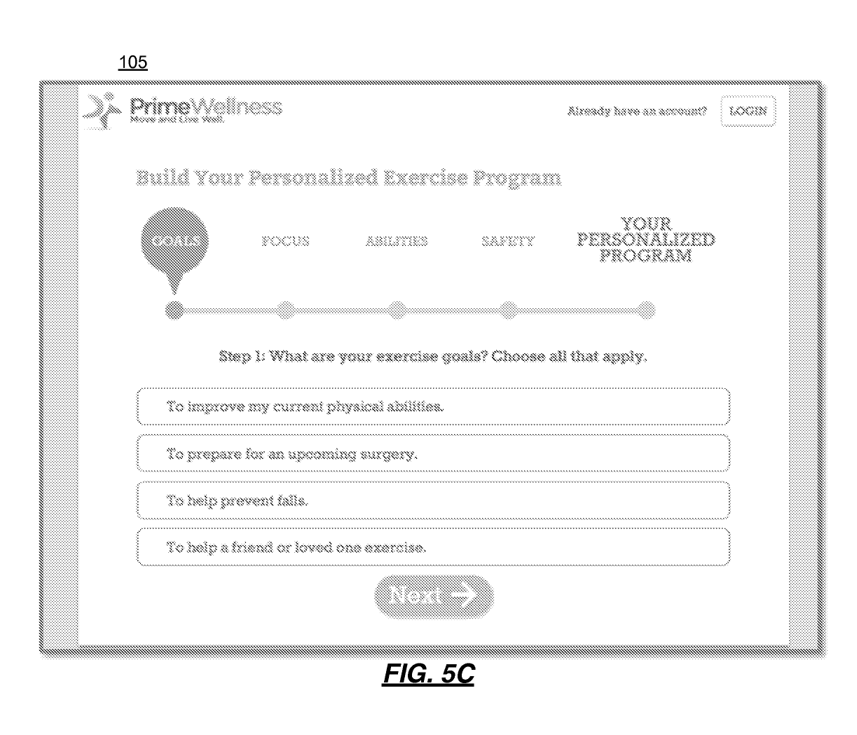

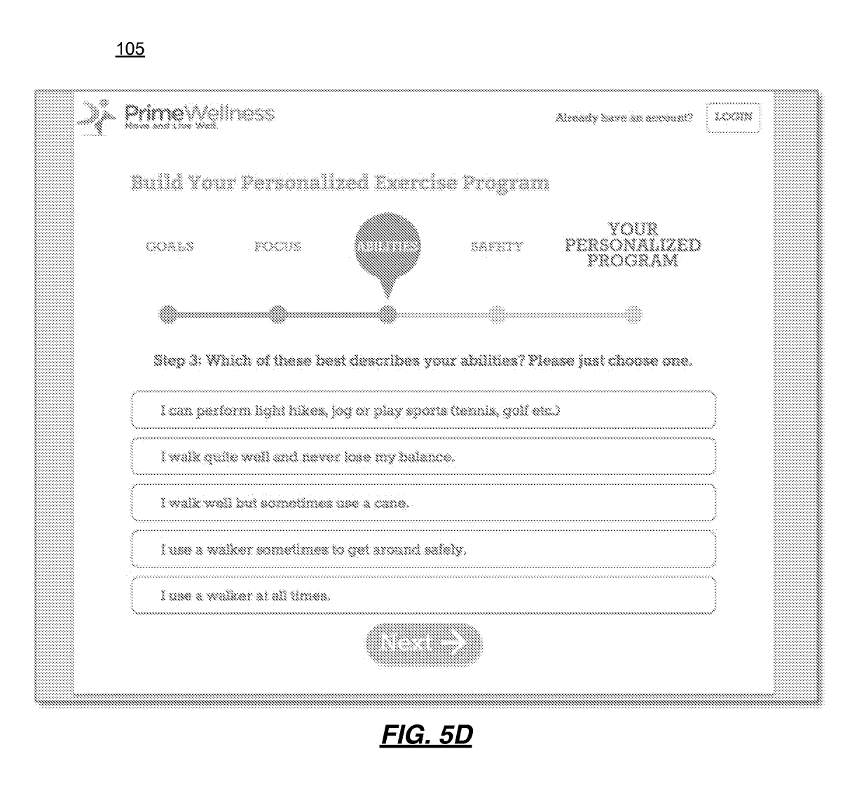

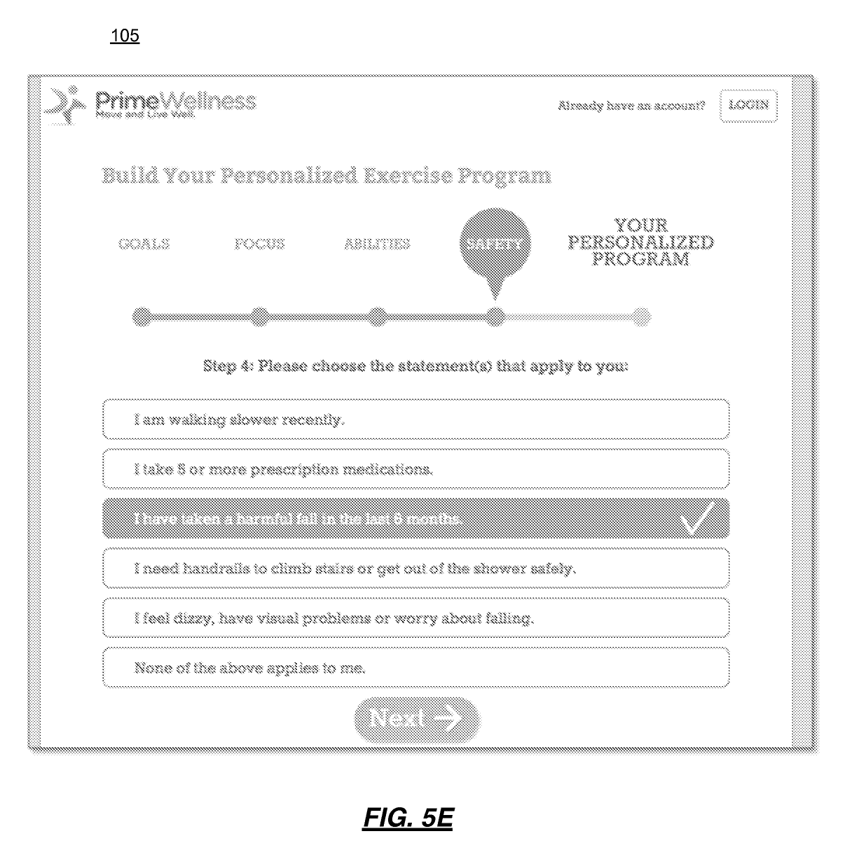

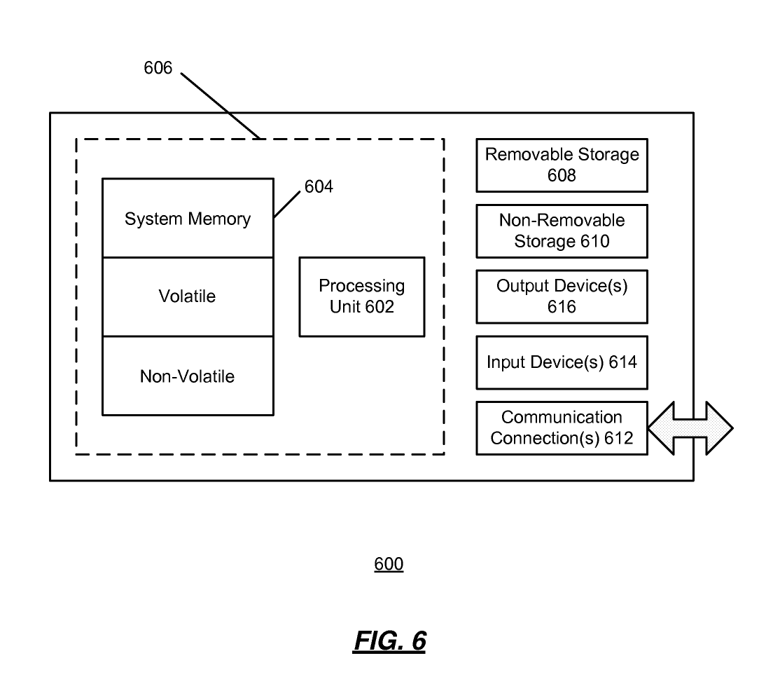

An example question-and-answer module 105 can be used to generate a baseline personalized exercise regime based on the goals and capabilities of the end user 102. The question-and-answer module 105 can include for example, questions related to the end user 102 goals, focus, ability, and safety as seen in FIGS. 5C-E. The answers to the questions can be used to ascertain the end user 102 current level of physical function. Depending on how the end-user answers the question, the software logic will route the end user 102 a baseline exercise program. An example exercise application 108 is shown in FIGS. 2A-C. The exercise program 108 can include one or more exercise modules (Module A, Module B, Module C and so on) that each may be distinct exercises, directed to for example, balance, strengthening and flexibility. The exercise application 108 can be influenced by the inputs of the end user 102, including the inputs from the question-and-answer module 105 as shown below.

An example question-and-answer module 105 can include a safety based question that can serve as an overriding factor in determining the appropriate baseline exercise regime. For example, if the end user 102 answers the safety question without claiming any risk factors (e.g., a recent fall suffered, poor eyesight, etc.) then the end user 102 inputs to the other questions are the determining factors, and the end user may be placed in a more difficult baseline exercise program as seen in FIG. 2B. Conversely, if the end user 102 selects a number of risk factors that surpasses a predetermined risk threshold, the end user 102 may be moved to a less rigorous and/or safer program as shown in FIG. 2C.

The following is a non-exclusive example of how a sample risk score may be established and used in the context of a first and second question. A first question may comprise, for example, an abilities question which asks as shown in FIG. 5D “which of these best describes your abilities? Please choose one.” This example question can include various possible answers including (a) “I can perform light hikes, jog or play sports (tennis, golf etc.),” (b) “I walk quite well and never lose my balance,” (c) “I walk well but sometimes use a cane,” (d) “I use a walker sometimes to get around safely,” and (d) “I use a walker at all times.”

A second question may comprise, for example, a safety question which asks as shown in FIG. 5E “Please choose the statement(s) that apply to you:” This example question can include various possible answers including (a) “I was walking slower recently”; (b) “I take 5 or more prescription medications”, (c) “I have taken a harmful fall in the last 6 months”, (d) “I need handrails to climb stairs or get out of the shower safely,” (e) “I feel dizzy, have visual problems or worry about falling” and (f) “None of the above applies to me.”

If in response to the first question the end user selects option (a) and if in response to the second question the end user selects option (f), then a risk value of “0” may be assigned to end user. The risk value of “0” can be associated with the selection of, for example, a rigors baseline exercise program.

If in response to the first question the end user selects an option other than option (a) and if the end user selects option (f) for question two, then the end user may be assigned a risk value of “1”. The risk value of “1” can be associated with the selection of, for example, an intermediate difficulty baseline exercise program.

If the end user selects any other answer to question 2 other than only selecting option (f), (i.e. if they claim any fall risk factors) then the end user may be automatically assigned a risk value of “2”, wherein the risk value is assigned irrespective of the answer selected by the end user to question one. The risk score value of 2″ can be associated with, for example, an easy difficult baseline exercise program.

Risk value scores can scale in an elastic fashion. As seen in the examples provided above, the risk score therein ranged from 0-2. In other examples the risk score can have a different range including for example a range of 0-5. The risk score and can be program-specific and depend on the clinical focus of the exercise program. The clinical focus of the exercise can be ascertained, for example, by providing the end user with question(s) regarding the end user's focus and goals, wherein the type of exercise is selected in accordance with the answer(s) received. Alternatively, the clinical focus of the exercise can be predetermined by an exercise program provider.

The video player/control panel 106 of the graphical user interface 104 can provide instructions to an exercise application 108. The exercise application 108 can supply the end user 102 with a series of exercise lessons on how to correctly perform physical therapy exercises relevant to their wellness. When the end user adheres to a particular exercise program 108 over, e.g., several weeks, or just days, their capabilities may improve. The graphical user interface 104 can allow the end user 102 to retrieve a harder exercise allows the end user 102 to self-manage their improvement instead of growing bored and quitting the program 108 because it is too easy. Conversely, sometimes an end user 102 may suffer a setback in his/her abilities (e.g. the end user suffers a fall) and he/she may need to make the exercises easier to account for this reduction in physical ability.

Optionally, if the end user 102 finds an exercise module to be too easy or too difficult, the end user 102 may activate a control to make the exercise associated with the exercise module harder or easier. For example, the end user 102 may switch from Exercise A2 to Exercise B3 if the end user 102 finds Exercise B2 too easy. Similarly, the end user 102 may switch from Exercise B3 to Exercise C2 if the end user 102 finds Exercise C3 too hard. Thus, the end user 102 is in control of the level of difficult at all times throughout the program 108, such that the end user 102 is challenged at a comfortable level of difficulty.

Referring again to FIG. 1, in accordance with the level of difficulty, a video may be retrieved from a server 110 and delivered over, e.g., the Internet or any other suitable network infrastructure to the video player/control panel 106 for display to the end user 102. The server 110 may contain video that is indexed for quick retrieval. The server may be a cloud service that enables a provider to organize each exercise into “buckets” (the modules). Each bucket contains multiple file types (.webm, .ogv. mp4) of the same exercise video. The end user's browser reaches into the bucket and pulls whichever file type it prefers, allowing the site to achieve cross-platform and cross-browser compatibility. The server 110 and the end-user computing devices described above may be implemented as an example computing device, as described below with reference to FIG. 6.

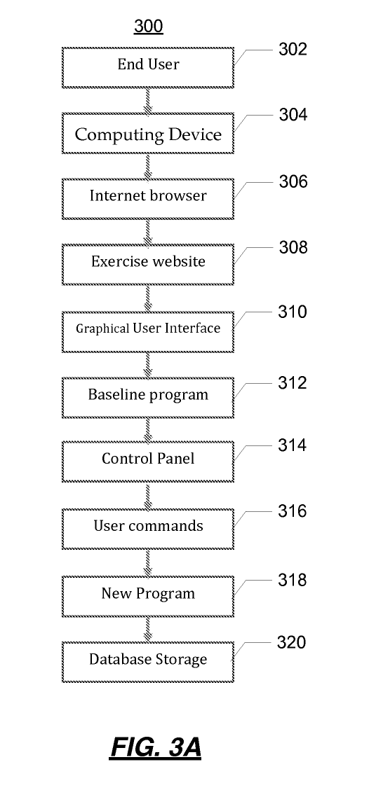

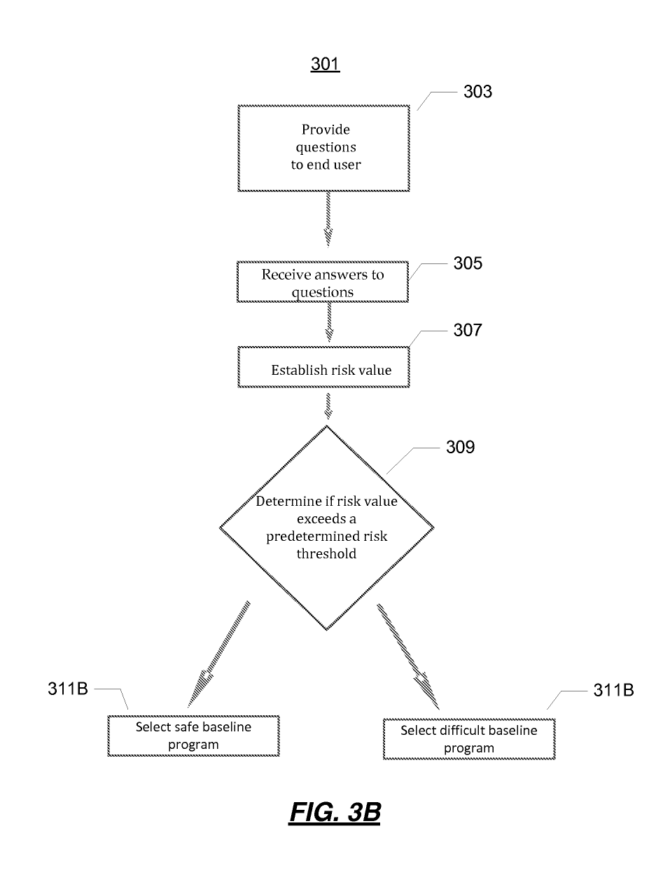

FIG. 3A illustrates an operational flow 300 of an example process in accordance with the present disclosure. At 302-306, the end user engages a computing device and opens, e.g., an Internet browser. At 308, utilizing the Internet browser, the end user 102 accesses the website associated with the exercise application provider. At 310, the website presents a graphical user interface to the end user 102, through which the end user inputs commands.

At 312, the end user 102 establishes their baseline program through a question-and-answer process and/or a “level setting” process.

FIG. 3B illustrates an operational flow 301 of an example process for establishing the baseline program using the question-and-answer module 105 in accordance with the present disclosure. At 303, a first question related to the ability of the end user 102 is provided to the end user 102 by a computing device. Additionally, a second question related to the safety of the end user 102 is also provided to the end user 102. At step 305, the computing device receives the answers from the end user 102, which are provided to the computing device by the end user 102 through the graphical user interface 104. At step 307, the computing device establishes a risk value based on the received answers to the first and second questions. At step 309, the computing device determines if the risk value exceeds a predetermined risk threshold. At step 311A, upon determining that the risk value exceeds the predetermined risk threshold, the computing devices selects a safe and/or low rigorous exercise as the baseline exercise program (FIG. 2C), the exercise can be predetermined by an exercise program provider. Alternatively, at step 311B, upon determining that the risk value does not exceed the predetermined risk threshold, the computing device can select a baseline exercise program that can be more rigorous as compared to the safe and/or low rigorous exercise (FIG. 2B).

Referring back to the example operational flow 300 shown in FIG. 3A. The level setting process can include taking an end user 102 through a series of modules (e.g. Balance 1, Balance 2, Strength 1, etc). Each module contains several exercises, each with a different level of difficulty. To establish the program, the end user may being each module with the easiest exercise.

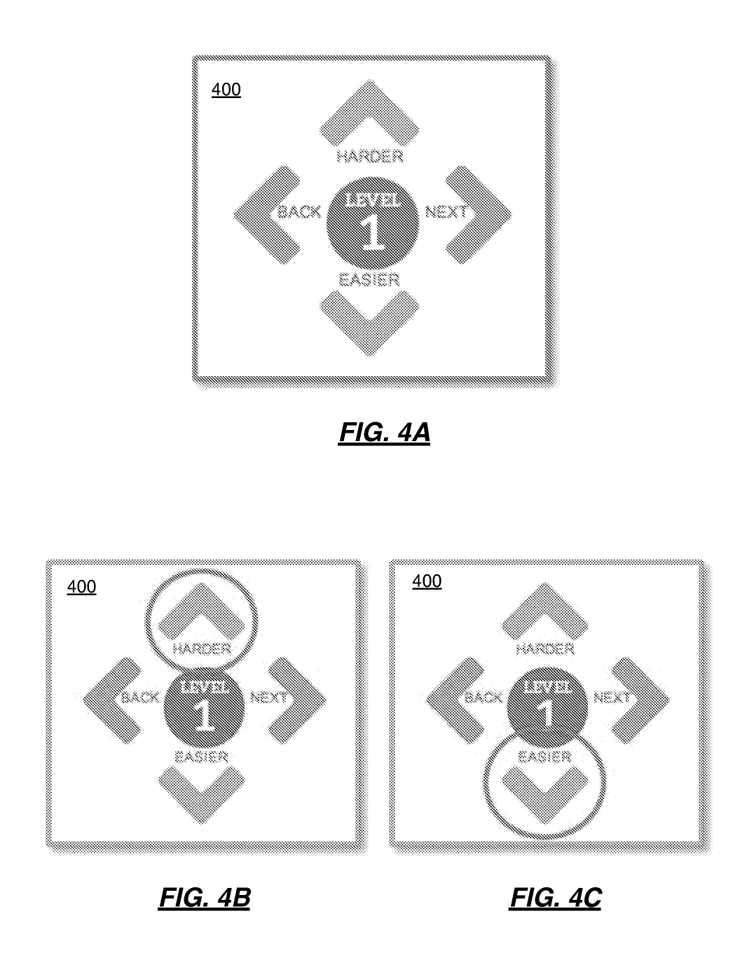

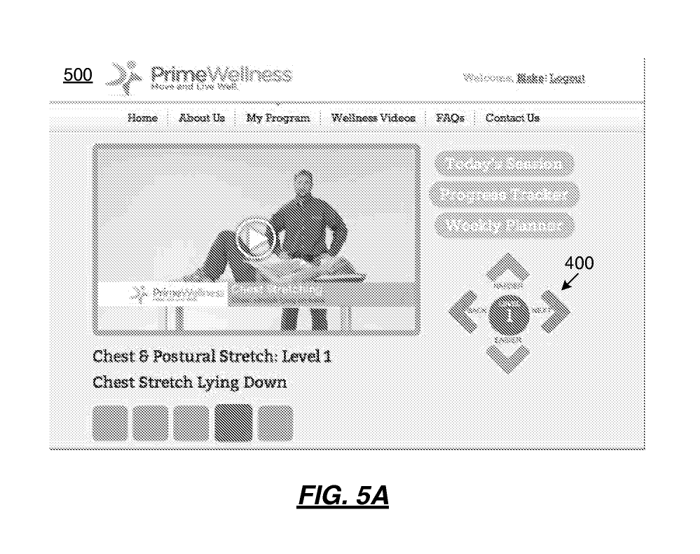

In accordance with the above, the end user 102 may be directed to either increase the level of difficulty with the module, or continue to the next module based on physical feedback cues provided by the content. To increase the level of difficulty, at 314, a control panel 400 is presented, such as that illustrated in FIGS. 4A-4C. As shown, the end user 102 may increase the level of difficultly by activating the “HARDER” (FIG. 4B) or decrease the level of difficulty by activating the “EASIER” button (FIG. 4C). Thus, the control panel 400 is the user interface element that enables the end user 102 to change core elements of the retrieved exercise videos, such as difficulty level.

Next, at a point in time when the end user 102 returns to access their program and wishes to alter the exercise difficulty level within a module, the end user 102 may input a command at 316 through the control panel 400, which retrieves the exercise of the next hardest difficulty level within that module. Each command results in a change of difficulty level only for the module in which the command was executed. The changes in difficulty levels within all modules result in a new, re-baselined program at 318 that may be stored in a database at 320 for future retrieval. In some implementations, the baseline and re-baselined programs are stored in a database on a per-user basis and retrieved by the application based upon user authentication performed on the website.

FIGS. 5A-E illustrate example user interfaces. FIG. 5A illustrates a “My Program” page 500, which is the principal web page delivering online exercise program content to the end user 102. The control panel 400 may be provided in the bottom right quadrant of the page 500 to enable the end user 102 to alternate between “Harder” and “Easier” difficulty levels. The difficulty level (with “1” being the easiest) is shown in the center circle within the control panel 400. FIG. 5B illustrates the “My Program” page 500 in which the end user 102 has activated the “Harder” button, prompting the program 108 to retrieve a more difficult exercise from the server 110. Subsequently, the level depicted in the center of the control panel 400 has changed to “2”. FIGS. 5C-E illustrates an example questions and answers module 105 that presents questions to the end user 102 and allows the end user 102 to select at least one of a plurality of answers in accordance with the present disclosure.

Thus, as described above, there is disclosed a mechanism that enables an end user to, on-the-fly, select a level of difficulty of a module within of an exercise program 108 to uniquely tailor the level of difficultly of the entire exercise program 108 to the end user's abilities and comfort level.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A graphical user interface for selecting and implementing a baseline exercise program comprising a question-and answer module displayable on a web page provided by a website associated with exercise application provider, the question-and answer module configured to:
provide to an end user at a computing device, through the web page, a first question related to ability of the end user;
provide to the end user, through the web page, a second question related to safety of the end user;
receive answers provided by the end user to the first and second questions;
establish a risk value based on the received answers to the first and second questions;
determine if the risk value exceeds a predetermined risk threshold;
upon determining that the risk value exceeds the predetermined risk threshold, select a predetermined safe exercise program as the baseline exercise program; and
upon determining that the risk value does not exceed the predetermined risk threshold, select an exercise program as the baseline exercise program that is more rigorous than the predetermined safe exercise program.

2. The graphical user interface of claim 1, further comprising a video player/control panel displayable on the web page, the video player/control panel configured to:
provide to the end user, through the web page, a series of exercise modules from the selected exercise program, wherein each exercise module in the series takes the end user through a plurality of exercises, each exercise having a different level of difficulty;
provide to the end user, through the web page, a user interface element that enables the end user to individually change the difficulty of the modules provided; and
for each module provided, direct the end user, through the webpage, to either increase the level of difficulty of the module, or continue to the next module based on physical feedback cues provided by content of the module.

3. The graphical user interface of claim 2, wherein the providing of the series of exercises modules comprises displaying a storyboard that depicts each of the exercises in a row of tiles below a video player, wherein if the level of difficulty with a module is changed, the relevant tile within the storyboard will change to denote the change to a different exercise.

4. The graphical user interface of claim 2, wherein the video player/control panel is further configured to receive an input command by the end user through the user interface element requesting to alter the exercise difficulty level within a module of the baseline program, and to retrieve an exercise from the next hardest difficulty level within the module.

5. The graphical user interface of claim 4, wherein each input command received results in a change of difficulty level only for the module in which the command was executed.

6. The graphical user interface of claim 4, wherein the change in difficulty within the module results in a new, re-baselined program that is stored in a database for future retrieval.

7. The graphical user interface of claim 6, wherein the baseline and re-baselined programs are stored in the database on a per-user basis and retrieved based upon user authentication performed on the website.

8. A method for selecting and implementing a baseline exercise program, the method comprising:
communicating a web page from a website associated with an exercise application provider to an end user at a computing device;
providing to the end user, through the web page, a first question related to ability of the end user;
providing to the end user, through the web page, a second question related to safety of the end user;
receiving answers provided by the end user to the first and second questions;
establishing a risk value based on the received answers to the first and second questions;
determining if the risk value exceeds a predetermined risk threshold;
upon determining that the risk value exceeds the predetermined risk threshold, selecting a predetermined safe exercise program as the baseline exercise program; and
upon determining that the risk value does not exceed the predetermined risk threshold, selecting an exercise program as the baseline exercise program that is more rigorous than the predetermined safe exercise program.

9. The method of claim 1, further comprising:
providing to the end user, through the web page, a series of exercise modules from the selected exercise program, wherein each exercise module in the series takes the end user through a plurality of exercises, each exercise having a different level of difficulty;
providing to the end user, through the web page, a control panel that enables the end user to individually change the difficulty of the modules provided; and
for each module provided, directing the end user, through the webpage, to either increase the level of difficulty of the module, or continue to the next module based on physical feedback cues provided by content of the module.

10. The method of claim 9, wherein the providing of the series of exercises modules comprises displaying a storyboard that depicts each of the exercises in a row of tiles below a video player, wherein if the level of difficulty with a module is changed, the relevant tile within the storyboard will change to denote the change to a different exercise.

11. The method of claim 9, further comprising:
after the setting of the baseline program, receiving an input command by the end user through the control panel requesting to alter the exercise difficulty level within a module of the baseline program, and retrieving an exercise from the next hardest difficulty level within the module.

12. The method of claim 11, wherein each input command received results in a change of difficulty level only for the module in which the command was executed.

13. The method of claim 11, wherein the change in difficulty within the module results in a new, re-baselined program that is stored in a database for future retrieval.

14. The method of claim 13, wherein the baseline and re-baselined programs are stored in the database on a per-user basis and retrieved based upon user authentication performed on the website.

15. A non-transitory computer-readable medium comprising instruction which, when executed by a processor, cause the processor to:
communicate a web page from a website associated with an exercise application provider to an end user at a computing device;
provide to the end user, through the web page, a first question related to ability of the end user;
provide to the end user, through the web page, a second question related to safety of the end user;
receive answers provided by the end user to the first and second questions;
establish a risk value based on the received answer to the first and second questions;
determine if the risk value exceeds a predetermined risk threshold;
upon determining that the risk value exceeds the predetermined risk threshold, select a predetermined safe exercise program as the baseline exercise program; and
upon determining that the risk value does not exceed the predetermined risk threshold, select an exercise program as the baseline exercise program that is more rigorous than the predetermined safe exercise program.

16. The non-transitory computer-readable medium of claim 15, further including instructions which, when executed by the processor cause the processor to:
provide to the end user, through the web page, a series of exercise modules from the selected exercise program, wherein each exercise module in the series takes the end user through a plurality of exercises, each exercise having a different level of difficulty;
provide to the end user, through the web page, a control panel that enables the end user to individually change the difficulty of the modules provided; and
for each module provided, direct the end user, through the webpage, to either increase the level of difficulty of the module, or continue to the next module based on physical feedback cues provided by content of the module.

17. The non-transitory computer-readable medium of claim 16, wherein the providing of the series of exercises modules comprises displaying a storyboard that depicts each of the exercises in a row of tiles below a video player, wherein if the level of difficulty with a module is changed, the relevant tile within the storyboard will change to denote the change to a different exercise.

18. The non-transitory computer-readable medium of claim 16, further including instructions which, when executed by the processor cause the processor to:
after the setting of the baseline program, receive an input command by the end user through the control panel requesting to alter the exercise difficulty level within a module of the baseline program which retrieves an exercise from the next hardest difficulty level within the module.

19. The non-transitory computer-readable medium of claim 18, wherein each input command received results in a change of difficulty level only for the module in which the command was executed.

20. The non-transitory computer-readable medium of claim 18, wherein the change in difficulty within the module results in a new, re-baselined program that is stored in a database for future retrieval, wherein the baseline and re-baselined program are stored in the database on a per-user basis and retrieved based upon user authentication performed on the website.
